(19) United States
(12) Patent Application Publication
(10) Pub. No.: US 2024/0131430 A1
(43) Pub. Date: Apr. 25, 2024

(54) RECORDING MEDIUM AND INFORMATION PROCESSING DEVICE

(71) Applicant: SEGA CORPORATION, Tokyo (JP)

(72) Inventor: Takahiro Otomo, Tokyo (JP)

(73) Assignee: SEGA CORPORATION, Tokyo (JP)

(21) Appl. No.: 18/404,010

(22) Filed: Jan. 4, 2024

Related U.S. Application Data
(63) Continuation of application No. PCT/JP2022/025469, filed on Jun. 27, 2022.

(30) Foreign Application Priority Data
Jul. 4, 2021 (JP) 2021-111855

(51) Int. Cl. A63F 13/533; A63F 13/58; A63F 13/69; A63F 13/825

(52) U.S. Cl. CPC A63F 13/533; A63F 13/58; A63F 13/69; A63F 13/825

(57) ABSTRACT

A non-transitory computer readable recording medium stores instructions causing a control device to execute: causing a controller to execute, in a training scenario, a training game and a challenge game in which a character attempts to achieve a target, in a specific order; awarding a skill point to the character based on an execution state of the training game or the challenge game; causing a display to display a skill acquisition screen in which the character acquires one or more skills from among acquirable skills of the character by consuming the skill point; when the character has acquired a skill that matches a condition included in the challenge game, activating the skill to be exhibited in the challenge game; and causing the display to display, on the skill acquisition screen, information on a condition included in a subsequently-executed challenge game.

### BACKGROUND

### Technical Field

The present invention relates to a recording medium storing instructions and an information processing device.

### Description of Related Art

There are conventional games in which characters associated with a player can be trained.

In this regard, Patent Literature 1 discloses a technique in which a player trains a character he possesses, changes the parameters and skills of the character, and uses that character in a game.

### PATENT LITERATURE

Patent Literature 1: Japanese Patent No. 6,787,513

In a gaming technology such as this, the player is sometimes able to select a skill to be acquired by a character being trained from among multiple types of skills. However, when selecting a skill to be acquired by a character being trained, the player could not instantly confirm which skill would be effective in a game to be executed later.

### SUMMARY

One or more embodiments of the present invention provide a technological improvement over such conventional gaming technologies discussed above. In particular, one or more embodiments of the present invention provide an information processing device and a recording medium storing instructions that enable clearer visualization of information on a condition for exhibiting a skill in a subsequently-executed challenge game. This improved configuration/function of the information processing device allow a player to easily recognize the skill that a character to be trained should acquire.

According to a first mode of the present invention, a non-transitory computer readable recording medium stores instructions for an information processing device that comprises a control device connected via a network to a terminal device that comprises a controller and a display, the instructions causing the control device to execute: causing the controller to execute, in a training scenario for training a character, a training game and a challenge game in which the character attempts to achieve a target, in a specific order; awarding a skill point to the character based on an execution state of the training game or the challenge game; and causing the display to display a skill acquisition screen in which the character acquires one or more skills from among acquirable skills of the character by consuming the skill point, when the character has acquired a skill that matches a condition included in the challenge game, activating that skill to be exhibited in the challenge game, and causing the display to display, on the skill acquisition screen, information on the condition included in a subsequently-executed challenge game.

The non-transitory computer readable recording medium according to a second mode of the present invention causes the control device to execute: causing the controller to execute, in a training scenario for training a character, a training game and a challenge game in which the character attempts to achieve a target, in a specific order; awarding a skill point to the character based on an execution state of the training game or the challenge game; and causing the display to display a skill acquisition screen in which the character acquires one or more skills from among acquirable skills of the character by consuming the skill point, when the character has acquired a skill that matches a condition included in the challenge game, activating the skill to be exhibited in the challenge game, causing the display to display, on the skill acquisition screen, a list of acquirable skills, wherein in the list, acquirable skills that match and acquirable skills that do not match a condition included in a subsequently-executed challenge game are displayed distinguishably from each other.

Also, in a third mode of the present invention, the instructions further cause the control device to add, to the acquirable skills, a skill selected with a predetermined probability through execution of the training game or the challenge game.

Also, in a fourth mode of the present invention, the predetermined probability changes depending on a support character used by a player in the training scenario.

Also, in a fifth mode of the present invention, the instructions further cause the control device to restrict continuation of the training scenario when a performance of the character in the challenge game does not satisfy a clearance condition of the challenge game.

Also, in a sixth mode of the present invention, the challenge game is a race in which the character competes in a race course, and the clearance condition is to place within a specific finish order.

Also, in a seventh mode of the present invention, the condition included in the subsequently-executed challenge game includes at least one of: a race course attribute, a race distance, a lap direction, a season, and a weather.

Also, the information processing device according to an eighth mode of the present invention comprises: a control device that: is connected via a network to a terminal device that comprises a controller and a display, causes the controller to execute, in a training scenario for training a character, a training game and a challenge game in which the character attempts to achieve a target, in a specific order, awards a skill point to the character based on an execution state of the training game or the challenge game, causes the display to display a skill acquisition screen in which the character acquires one or more skills from among acquirable skills of the character by consuming the skill point, when the character has acquired a skill that matches a condition included in the challenge game, activates the skill to be exhibited in the challenge game, and causes the display to display, on the skill acquisition screen, information on a condition included in a subsequently-execute challenge game.

The information processing device according to a ninth mode of the present invention comprises: a control device that: is connected via a network to a terminal device that comprises a controller and a display, causes the controller to execute, in a training scenario for training a character, a training game and a challenge game in which the character attempts to achieve a target, in a specific order, awards a skill point to the character based on an execution state of the training game or the challenge game, causes the display to display a skill acquisition screen in which the character acquires one or more skills from among acquirable skills of the character by consuming the skill point, when the character has acquired a skill that matches a condition included in the challenge game, activates the skill to be exhibited in the challenge game, and causes the display to display, on the skill acquisition screen, a list of acquirable skills, wherein in the list, acquirable skills that match and acquirable skills that do not match a condition included in a subsequently-execute challenge game are displayed distinguishably from each other.

One or more embodiments of the present invention enable clearer visualization of the information on the condition for exhibiting the skill in the subsequently-executed challenge game. This improved configuration/function of the information processing device allow the player to easily recognize the skill that the character to be trained should acquire.

### BRIEF DESCRIPTION OF THE DRAWINGS

FIG. 1 is a block diagram showing an example of the overall configuration of a game system according to this embodiment;

FIG. 2 is a diagram schematically showing an example of the hardware configuration of a server device;

FIG. 3 is a diagram showing an example of the hardware configuration of a smart phone, as the terminal device shown in FIG. 1;

FIG. 4 is a block diagram schematically showing an example of the functional units of a server device;

FIG. 5 is a flowchart showing an example of the flow of processing performed by each functional units shown in FIG. 4 in the game system according to this embodiment;

FIG. 6 is a figure showing an example of the skill acquisition screen according to this embodiment; and

FIG. 7 is a figure showing an example of the challenge game information screen according to this embodiment.

### DETAILED DESCRIPTION OF EMBODIMENTS

An embodiment (hereinafter, “this embodiment”) of the present invention will now be described with reference to the appended drawings. To facilitate understanding of the description, components and steps that are the same will be numbered the same as much as possible in the drawings, and redundant description will be omitted.

Overall Configuration

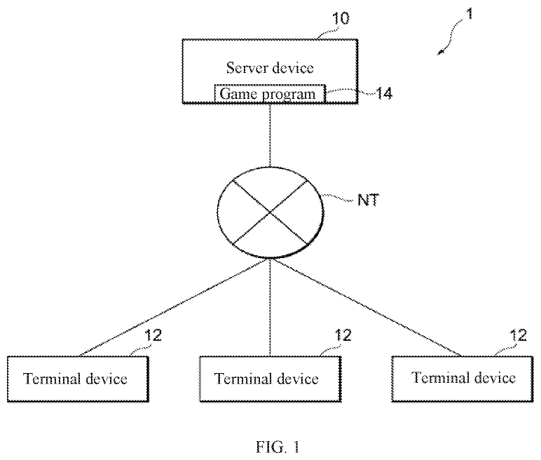

FIG. 1 is a block diagram showing an example of the overall configuration of a game system 1 according to this embodiment.

As shown in FIG. 1, a game system 1 comprises a server device 10 and one or more terminal devices 12. The server device 10 and terminal devices 12 are connected so as to be able to communicate via a communication network NT such as an intranet, the Internet, or a telephone line.

The server device 10 is an information processing device that provides the execution results of the game obtained by executing instructions such as a game program 14, or the instructions themselves, to the player of each terminal device 12 via the communication network NT. In this embodiment, the server device 10 provides the instructions themselves to the players of the terminal devices 12.

Each terminal device 12 is an information processing device belonging to a player, and is an information processing device that provides a game to a player by executing the instructions received from the server device 10 after the instructions has been installed. Examples of these terminal devices 12 include video game machines, arcade game machines, mobile phones, smartphones, tablets, personal computers, and various other such devices.

Hardware Configuration

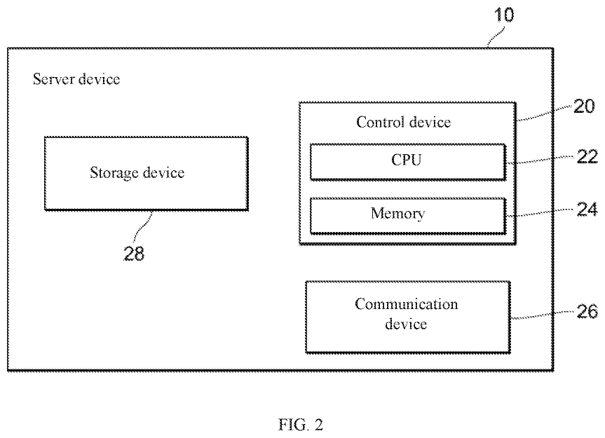

FIG. 2 is a diagram schematically showing an example of the hardware configuration of the server device 10.

As shown in FIG. 2, the server device 10 comprises a control device 20, a communication device 26, and a storage device 28. The control device 20 mainly comprises a CPU (central processing unit) 22 and a memory 24.

In the control device 20, the CPU 22 functions as various functional units by executing instructions such as specific programs stored in the memory 24, the storage device 28, or the like. These functional units will be described in detail below.

The communication device 26 is constituted by a communication interface or the like for communicating with an external device. The communication device 26 sends and receives various kinds of information to and from the terminal device 12, for example.

The storage device 28 is constituted by a hard disk or the like. The storage device 28 stores various kinds of instructions and various kinds of information necessary for executing processing in the control device 20, including the game program 14, as well as information about processing results.

The server device 10 can be realized by using an information processing device such as a dedicated or general-purpose server computer. Also, the server device 10 may be constituted by a single information processing device, or may be constituted by a plurality of information processing devices distributed on the communication network NT. Also, FIG. 2 shows only a part of the main hardware configuration of the server device 10, and the server device 10 can comprise other components that are ordinarily provided to a server. Also, the hardware configuration of the plurality of terminal devices 12 may have the same configuration as the server device 10, except for further comprising an operating device, a display device, and a sound output device, for example.

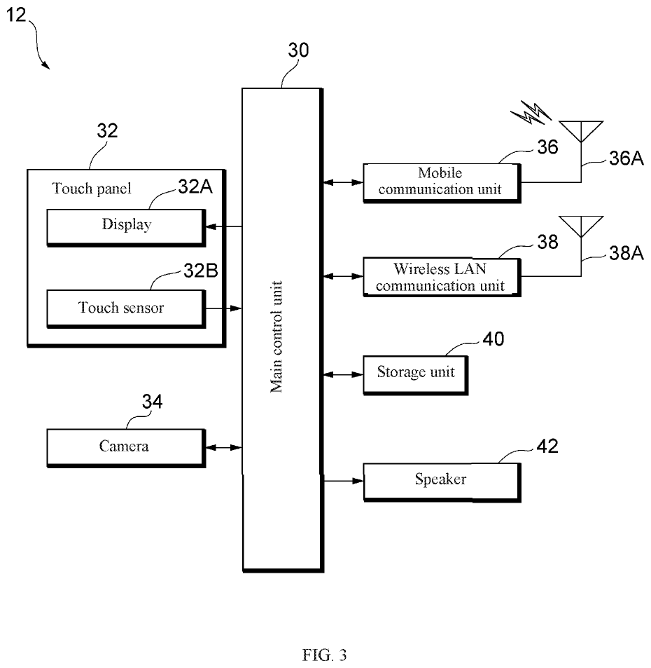

FIG. 3 is a diagram showing an example of the hardware configuration of a smartphone serving as the terminal device 12 shown in FIG. 1.

As shown in FIG. 3, the terminal device 12 comprises a main control unit (controller) 30, a touch panel or display (touch screen) 32, a camera 34, a mobile communication unit (mobile communication interface) 36, a wireless LAN communication unit (wireless LAN communication interface) 38, a storage unit (storage) 40, and a speaker 42.

The main control unit 30 includes a CPU, a memory, and the like. This main control unit is connected to the touch panel 32 (used as a display or a display input device), the camera 34, the mobile communication unit 36, the wireless LAN communication unit 38, the storage unit 40, and the speaker 42. The main control unit 30 has the function of controlling these connected devices.

The touch panel 32 has both a display function and an input function, and is constituted by a display 32A that handles the display function, and a touch sensor 32B that handles the input function. In this embodiment, the display 32A can display game images including button images, a cross key image, a joystick image, and other such operation input images. The touch sensor 32B can sense the input position of the player with respect to a game image.

The camera 34 has the function of capturing still and/or moving images and storing these images in the storage unit 40.

The mobile communication unit 36 is connected to a mobile communication network via an antenna 36A, and has the function of communicating with other communication devices that are connected to this mobile communication network.

The wireless LAN communication unit 38 is connected to the communication network NT via an antenna 38A, and has the function of communicating with other devices, such as the server device 10, that are connected to the communication network NT.

The storage unit 40 stores various kinds of instructions and data, such as the game program 14, and play data indicating player information or the progress of the game in the instructions. This play data may be stored in the server device 10.

The speaker 42 has the function of outputting game sounds and so forth.

Game Overview

The game according to this embodiment includes a training scenario in which a character is trained, a battle game, and the like.

The training scenario according to this embodiment includes a training game and a challenge game. In this training scenario, a training game and a challenge game are executed in a specific order. For instance, the training scenario includes a specific number of turns (such as 50) from start to end. Each turn is associated with a training game or a challenge game. For instance, in the training scenario, the player can execute a game (such as training game) associated with the current turn (such as turn 5) and thereby proceed to a game (such as a challenge game) associated with the next turn (such as turn 6).

For example, a player can acquire (possess) a character to be trained or a support character by playing a lottery game (such as a gacha). The character to be trained and the support character are added one after another through game updates.

Also, for example, before starting the training scenario, the player arbitrarily selects one character to be trained from among his possessed characters, and then arbitrarily selects one or more support characters to be used from among his possessed characters. The player then starts the training scenario, and can thereby change various parameters of the character to be trained, or have the character to be trained acquire skills, using the basic parameters and basic skills of the character to be trained as initial values. The player can train the same character to be trained (possessed character) any number of times in a training scenario.

Also, the training scenario ends when the performance of the character to be trained does not satisfy a clearance condition of the challenge game associated with an intermediate turn, or when the last turn (such as turn 50) has been executed.

The training game according to this embodiment is a game in which various parameters of a character to be trained are changed (increased or decreased), and skill points are awarded to the character to be trained. For example, in a training game, various parameters of the character to be trained (such as speed, stamina, power, guts, wisdom, physical strength, enthusiasm, and so on) can be changed by having the character to be trained either perform training, take a rest, or run a practice race in one turn. There are a number of types of training, and the parameters to be changed and the amount of change will vary with the type of training selected by the player. Also, in this training game, skill points can be awarded to (acquired by) the character to be trained by having the character to be trained perform training or run a practice race. These skill points are points consumed in order for the character to be trained to acquire skills.

The challenge game according to this embodiment is a game in which a character to be trained attempts to achieve a target. For example, a challenge game can be a race (a challenge race) in which the character to be trained competes in a race course. The result of this challenge game depends on the various parameters and skills of the character to be trained in the current turn, for example. For instance, before executing the challenge game, on the skill acquisition screen, the player can consume skill points awarded to the character to be trained, and thereby acquire one or more skills for the character to be trained from among the acquirable skills of the character to be trained.

Also, in a challenge game, the continuation of the training scenario (proceeding to the next turn) is restricted if the performance of the character to be trained does not satisfy a clearance condition of the challenge game. The clearance condition may include, for example, placing within a specific finish order (such as within third place) in a race (competition). For example, the training scenario would end if the character to be trained fails to place within a specific finish order.

Also, the battle game according to this embodiment is a game in which a character to be trained in a training scenario battles an enemy character. This enemy character may be, for example, a character that has been trained by another player, or an NPC (non-player character). Also, examples of battle games include a competitive race using various parameters and skills for which the character to be trained has undergone training. When the player wins a battle game, he is able to acquire rewards such as items and coins.

Functional Units

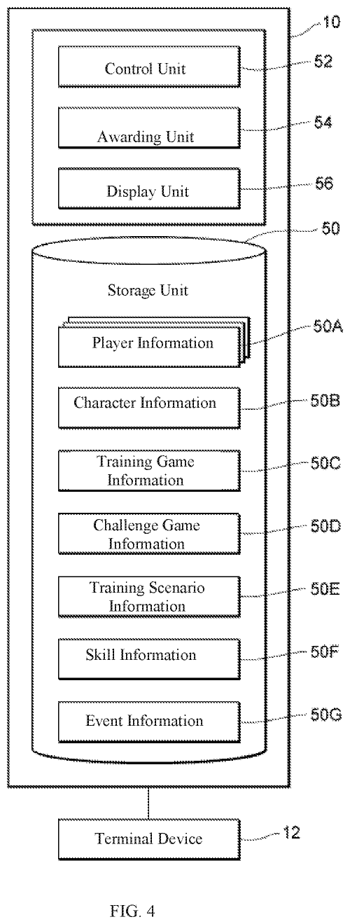

FIG. 4 is a block diagram schematically showing an example of the functional units of the server device 10.

As shown in FIG. 4, the server device 10 comprises, as functional components, a storage unit 50, a control unit 52, an awarding unit 54, and a display unit 56. The storage unit 50 is realized in the form of one or more storage devices 28. Functional units other than the storage unit 50 are realized when the control device 20 executes the instructions stored in the storage device 28 or the like.

The storage unit 50 has the function of storing player information 50A, character information 50B, training game information 50C, challenge game information 50D, training scenario information 50E, skill information 50F, event information 50G, and so forth.

Player information 50A is stored for each player in association with the player ID of that player. This player information 50A includes, for example, the player's name, age, player rank, possessed content information, stamina information, and so forth.

Possessed content information includes possessed character information, possessed item information, possessed coin information, and so forth. Possessed character information includes a character ID for each character possessed by the player, and basic parameters, current parameters, basic skills, acquired skills, acquirable skills, and current skill points of each character. These possessed characters include characters to be trained and support characters that support the training of the characters to be trained in the training scenario. Basic parameters include parameters before the start of the training scenario. Current parameters include parameters after the start of the training scenario. Basic parameters and current parameters of a character to be trained may include, for example, speed, stamina, power, guts, wisdom, physical strength, and enthusiasm, and so on. Basic parameters and current parameters of a support character may include, for example, the change rate at which various parameters of the character to be trained are changed (increased) in a training scenario, and the amount of change (such as the rate of increase) in the event occurrence rate. Basic skills include unique skills (skill IDs) that have been acquired by a character to be trained before the start of a training scenario. Acquired skills include skills (skill IDs) acquired by a character to be trained after the start of a training scenario. Acquirable skills include skills (skill IDs) that can be acquired by a character to be trained after the start of a training scenario. These acquirable skills may be added, for example, when an event has occurred in a training scenario. Current skill points include skill points possessed by a character to be trained after the start of a training scenario.

Possessed item information includes the item ID and number of each item possessed by the player. These items include paid stones, free stones, stamina recovery items, reinforcement resource items, and so forth. These paid stones and free stones are consumed at the execution of a lottery game or when recovering stamina. Also, a reinforcement resource item is consumed, for example, when strengthening a basic parameter of a character to be trained before the start of a training scenario.

Possessed coin information includes the number of coins possessed by the player. These coins are consumed, for example, when strengthening a basic parameter of a support character.

Stamina information includes the player's current stamina value and stamina upper limit value. The current stamina value is the value consumed when the player executes a training scenario. This current stamina value increases by a specific amount (such as 1) after a certain period of time (such as 3 minutes) elapses, and recovers to the stamina upper limit value. Also, this current stamina value recovers beyond the stamina upper limit value when the player consumes paid stones, free stones, stamina recovery items, and so on. This stamina upper limit value may be a fixed value (such as 100), or a value that is contingent on the ranking of the player.

Character information 50B is stored for each character in association with the character ID of that character. Character information 50B includes, for example, the character name and image, ability parameter information, and rarity. This character information 50B is updated from time to time via a game update by the game operator.

Parameter information includes the initial values and maximum values for the various parameters of a character.

Rarity may be represented by a number from 1 to 6, for example. This number may be indicated by a number of stars, for example. For instance, a high-rarity character to be trained may be configured with parameters and skills that are advantageous in a challenge game, a battle game, etc. Also, for instance, a high-rarity support character may be configured with a change rate that will advantageously change the parameters of the character to be trained in a training game.

Training game information 50C is stored for each training game in association with the training game ID of that training game. Training game information 50C includes result information according to an execution state of a training game (such as various kinds of training). This result information includes the amount of change in a parameter and the awarded skill points. For example, in this embodiment, a training game includes a first training game and a second training game. The first training game is a normal training game that allows training at a normal training facility. By contrast, the second training game is a special training game that allows training at a training camp. For example, in a special training game, the amount of change (such as the amount of increase) in a parameter that changes based on an execution state of training or an amount of skill points awarded is larger than in a normal training game.

Challenge game information 50D is stored for each challenge game in association with the challenge game ID of that challenge game. Challenge game information 50D includes race conditions, rival character information, and reward information. Race conditions include race name, race course attributes, race distance, lap direction (counterclockwise or clockwise), season (of the year), weather (sunny, cloudy, rain, snow), gate number (1 to 6), rival character strategies, clearance conditions, and so on. Race course attributes include the name of the race course and its condition (firm, yielding, soft, heavy). Race distance includes the distance of the race course, from start to finish. Examples of distance include short distance, medium distance, and long distance. For instance, if the race distance is a long distance (2500 to 3600 m), a character to be trained that has a high stamina parameter value will be advantageous. Clearance conditions include conditions for proceeding to the next turn. An example of the clearance condition may be that the performance in a challenge game (a challenge race) is to place within a specific finish order. Rival character information includes the character ID, parameters, and skills of characters that run in a race together with the character to be trained. These rival characters may be NPCs, for example. Reward information includes a reward that corresponds to the performance in a challenge game (such as finish order). Examples of rewards include skill points, various parameters, items, and the like. In this embodiment, the better the performance in a challenge game, the more rewards (such as skill points) are granted.

Training scenario information 50E is stored for each training scenario in association with the training scenario ID of that training scenario. Training scenario information 50E includes the name of the training scenario, stamina consumption, turn information, and the like.

Consumed stamina includes the quantity of stamina that is consumed when executing a training scenario one time. For example, the consumed stamina of a given training scenario may be 30. Also, the consumed stamina in another training scenario may be 40, for example.

Turn information includes the number of turns included in a training scenario and game information associated with each turn. For example, the number of turns in a given training scenario may be 50. Game information includes a training game ID or a challenge game ID.

For instance, in a given training scenario, turns 1-5, 7-15, 27-35, and 37-45 may be associated with a first training game (a normal training game), turns 17-25 with a second training game (a special training game), and turns 6, 16, 26, 36, and 46-50 with a challenge game (a challenge race). Skill information 50F is stored for each skill in association with the ID of that skill.

Skill information 50F includes skill effects, activation conditions, and consumed skill points. Effects here are effects that are exhibited in a challenge game or a battle game. Examples of these effects may include “becoming proficient at race course A,” “becoming proficient at long distances,” “becoming proficient in firm conditions,” “becoming proficient in summer races,” “becoming proficient in rainy conditions,” “becoming proficient in clockwise races,” “becoming proficient in races with a starting gate number of 1 to 3,” and “becoming proficient in races where there are no rival characters with the same strategy.” Activation conditions include race conditions under which a skill is activated. For example, the activation conditions may include race conditions related to attributes (name and condition) of a race course, race distance, lap direction, season, weather, gate number (starting gate), strategy of rival characters, and so forth. For example, if the effect of a skill is “becoming proficient at race course A,” the activation condition is that the name of the race course included in the race condition is “race course A.” Also, for example, if the effect of a skill is “becoming proficient at long distances,” the activation condition is that the race distance included in the race condition is “long distance (2500 to 3600 m).” Also, for example, if the effect of a skill is “becoming proficient in firm conditions,” the activation condition is that the condition of the race course included in the race conditions is “firm.” Also, for example, if the effect of a skill is “becoming proficient in summer races,” the activation condition is that the season included in the race condition is “summer (June to August).” Also, for example, if the effect of a skill is “becoming proficient in rainy conditions,” the activation condition is that the weather included in the race condition is “rainy.” Also, for example, if the effect of a skill is “becoming proficient in clockwise races,” the activation condition is that the lap direction included in the race condition is “clockwise.” Also, for example, if the effect of a skill is “becoming proficient in races with a starting gate number of 1 to 3,” the activation condition is that the starting gate number included in the race condition is any of “1 to 3.” For example, if the effect of a skill is “becoming proficient in races where there are no rival characters with the same strategy,” the activation condition is that the strategies of all rival characters included in the race conditions must be different from the strategies of the character being trained. Consumed skill points include the number of points consumed to acquire a skill.

Event information 50G is stored for each event in association with the event ID of the event. Event information 50G includes the event name, event effect, occurrence rate, event image, and the like. Event effect includes the amount of change by which a parameter of the character to be trained is changed due to the occurrence of an event, and a skill (skill ID) that is added to the acquirable skills of a character to be trained. Occurrence rate includes a predetermined probability or specific odds that an event will occur. In this embodiment, an event lottery is performed based on this occurrence rate through the execution of a training game or a challenge game. For example, the total occurrence rate (specific odds) of each event may be 40%. That is, the probability that the event will not occur is 60%. Also, these specific odds (occurrence rate) change or vary depending on the support characters used by the player in a training scenario. For example, if a support character A is used in a training scenario, the occurrence rate of event Z may increase by 3%, and the occurrence rate of the remaining events would decrease by 3% overall. Event image is an image displayed when an event occurs. This event image may include, for example, an image showing an event effect (the amount of change in parameters and acquirable skills).

The control unit 52 is a functional unit for controlling the entire game. In this embodiment, the control unit 52 executes, in a specific order, a training game and a challenge game in which a character to be trained attempts to achieve a target in a training scenario for training the character. For example, the control unit 52 refers to the turn information of the training scenario information 50E and executes, in a specific order, a training game or a challenge game on each turn.

Also, in this embodiment, when the character to be trained has acquired a skill that matches a condition (race conditions) included in the challenge game, the control unit 52 activates that skill to advantageously execute the challenge game. For example, the control unit 52 refers to the basic skills and acquired skills of the character to be trained (possessed character) in the player information 50A, the race conditions in the challenge game information 50D, and the activation conditions in the skill information 50F, and extracts the skills (basic skills or acquired skills) of the character to be trained that match the activation conditions. The control unit 52 then activates the extracted skills in the challenge game (a challenge race), and performs control so that the character to be trained has an advantageous performance (a high finish order) in the challenge game.

Also, in this embodiment, the control unit 52 sets the skills selected with specific odds through the execution of the training game or the challenge game as acquirable skills of the character to be trained. For example, on each turn, the control unit 52 executes a training game or a challenge game in response to a request (operation instruction) from a player. Subsequently, the control unit 52 refers to the occurrence rate in the event information 50G, performs an event lottery according to the occurrence rate, and selects an event to be generated. The control unit 52 then refers to the skills in the event information 50G and adds any skills corresponding to the selected event to the acquirable skills of the character to be trained. These specific odds change depending on the support characters used by the player in a training scenario.

Also, in this embodiment, the control unit 52 restricts (or prevents) continuation of the training scenario when the performance of the character to be trained in a challenge game does not satisfy a clearance condition of the challenge game. For example, the control unit 52 refers to the clearance conditions of the race conditions in the challenge game information 50D, and ends the training scenario if the performance (such as the finish order) of the character to be trained in the challenge game (a challenge race) does not satisfy the clearance condition (such as within third place).

The awarding unit 54 is a functional unit for granting rewards and the like to the character to be trained. In this embodiment, the awarding unit 54 changes (e.g., increases) the parameters of the character to be trained or awards skill points to the character to be trained based on the execution state of the training game or the challenge game by the control unit 52. For example, the awarding unit 54 refers to the result information in the training game information 50C and changes (e.g., increases) the parameters of the character to be trained in accordance with the execution state of the training game (such as various kinds of training) selected by the player. Also, for example, the awarding unit 54 refers to the awarded skill points in the training game information 50C and awards skill points in accordance with the execution state of the selected training game. Also, for example, the awarding unit 54 refers to the reward information in the challenge game information 50D and awards skill points according to the performance in a challenge game (a challenge race).

The display unit 56 is a functional unit for causing the touch panel 32 of the terminal device 12 to display various kinds of screens related to the game. In this embodiment, the display unit 56 displays a skill acquisition screen in which a character to be trained acquires one or more skills from among the acquirable skills of the character to be trained by consuming the awarded skill points (current skill points) by the awarding unit 54. For example, the display unit 56 refers to the acquirable skills or current skill points of the character to be trained in the player information 50A, and the skill effects, activation conditions, and consumed skill points in the skill information 50F, and causes the touch panel 32 to display a skill acquisition screen.

Also, for example, information on conditions included in a challenge game to be executed later is displayed on the skill acquisition screen. For example, the display unit 56 refers to the race conditions in the challenge game information 50D and the turn information in the training scenario information 50E, and displays on the skill acquisition screen information on the race conditions included in one or more challenge games (challenge races) associated with the current turn onward. This information may be the race conditions themselves, a button for pop-up display of the race conditions, or a switch button for switching to a screen displaying the race conditions (challenge game information switch button; discussed below). When a switch button is displayed on the skill acquisition screen, the display unit 56 may refer to the race conditions in the challenge game information 50D or the turn information in the training scenario information 50E in response to the pressing of the switch button, and display the race conditions included in the challenge game (a challenge race).

Also, for example, a list of acquirable skills of the character to be trained is displayed on the skill acquisition screen. For example, the display unit 56 refers to the acquirable skills of a character to be trained (possessed character) in the player information 50A, and displays in list format the acquirable skills of the character to be trained on the skill acquisition screen. For example, in this list, skills that match and skills that do not match a condition included in the challenge game to be executed later are displayed in different formats. More specifically, the display unit 56 refers to the turn information in the training scenario information 50E or the activation conditions in the skill information 50F, displays a mark on any skills that match the race conditions included in one or more challenge games associated with the current turn onward, and does not display a mark on those skills that do not match.

Flow of Processing

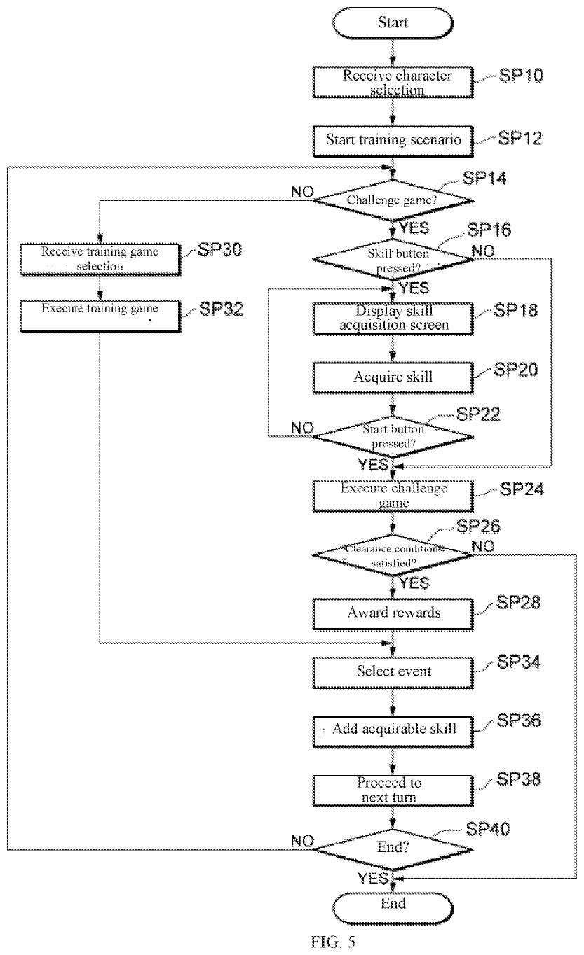

FIG. 5 is a flowchart showing an example of the flow of processing performed by each functional unit shown in FIG. 4 in the game system according to this embodiment. Also, the processing of the following steps is started, for example, at the point when a training scenario is selected by the player in the training scenario menu. The order and details of the following steps can be changed as needed.

(Step SP10)

The display unit 56 refers to the possessed character information in the player information 50A and causes the touch panel 32 to display a list of characters to be trained from among the possessed characters of the player. The control unit 52 then receives from the player the selection of a character to be trained from among the displayed list of characters to be trained. The display unit 56 then refers to the possessed character information in the player information 50A and causes the touch panel 32 to display a list of support characters from among the player's possessed characters. The control unit 52 then receives from the player the selection of a specific number of (such as five) support characters to be used from among the displayed list of characters to be trained. The processing then moves to the processing of step SP12.

(Step SP12)

The control unit 52 assigns an initial value of 1 to the current turn of the training scenario and starts the training scenario. Then, the processing moves to the processing of step SP14.

(Step SP14)

The control unit 52 refers to the turn information in the training scenario information 50E and determines whether or not a challenge game is associated with the current turn. For example, the control unit 52 makes a negative determination if a training game (first training game or second training game) is associated with the current turn. If the determination is positive, the processing then moves to the processing of step SP16. On the other hand, if the determination is negative, the processing moves to the processing of step SP30.

(Step SP16)

The display unit 56 causes the touch panel 32 to display a challenge game start screen that includes a challenge game start button and a skill button. The control unit 52 then determines whether or not the player has pressed the skill button. For example, the control unit 52 makes a negative determination if the challenge game start button has been pressed by the player. If the determination is positive, the processing then moves to the processing of step SP18. On the other hand, if the determination is negative, the processing moves to the processing of step SP24.

(Step SP18)

The display unit 56 refers to the acquirable skills and current skill points of the character to be trained in the player information 50A, and the skill effects, activation conditions, and consumed skill points in the skill information 50F, and causes the touch panel 32 to display a skill acquisition screen.

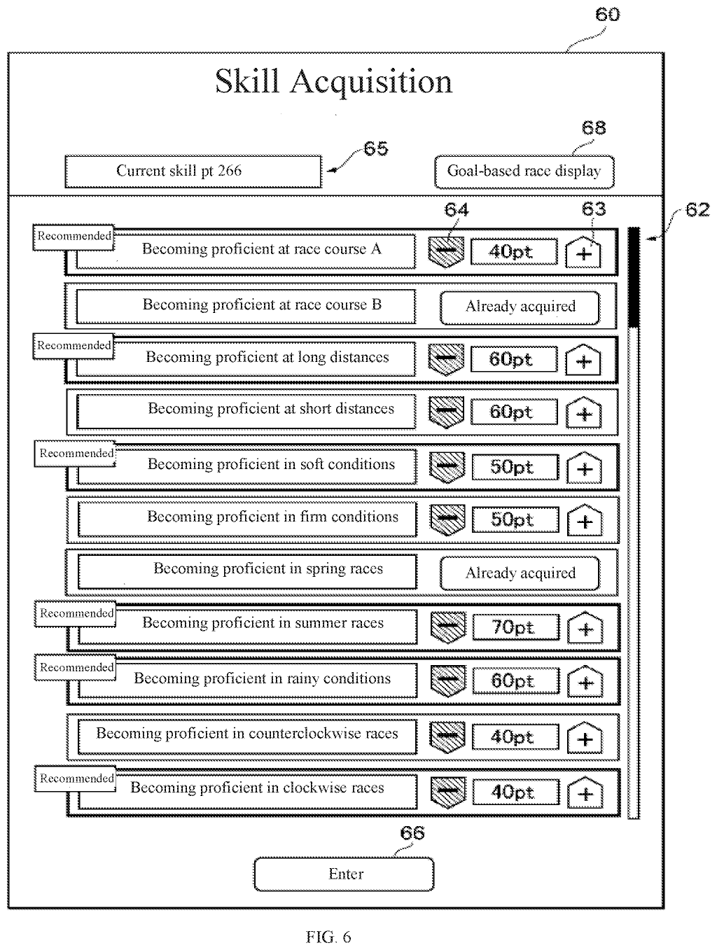

FIG. 6 is a diagram showing an example of the skill acquisition screen 60 according to this embodiment.

As shown in FIG. 6, the skill acquisition screen 60 includes an acquirable skill information area 62, an acquire button 63, an acquisition cancel button 64, a skill point information area 65, an enter button 66, and a switch button 68. The acquirable skill information area 62 shows a list of a plurality of types of skills (acquirable skills) that can be acquired by the character to be trained, along with consumed skill points. In this list, skills that match and skills do not match the race conditions (such as the race name, race course attributes, race distance, lap direction, season, weather) included in the challenge race to be executed later are displayed in different formats. For example, in this list, skills that match the race conditions included in the next challenge race to be executed (such as the challenge race associated with the current turn) are marked as “recommended,” and skills that do not match are not marked as such. Also, in this list, skills that have and have not been acquired by the character to be trained are shown in different formats. For example, in this list, skills that have been acquired by the character to be trained are grayed out. The acquire button 63 is a button for acquiring an associated skill. For example, when the acquire button 63 is pressed, the consumed skill points of the associated skill are consumed (subtracted) from the current skill points. The acquisition cancel button 64 is a button for canceling the acquisition of an associated skill. When the acquisition cancel button 64 is pressed, the consumed skill points of the associated skill are added to the current skill points. This acquisition cancel button 64 can be pressed, for example, after the corresponding acquire button 63 has been pressed and before the enter button 66 is pressed. The skill point information area 65 shows the current skill points possessed by the character to be trained. The enter button 66 is a button for deciding to acquire, from the list, those skills for which the acquire button 63 was pressed. The switch button 68 is a button for displaying a challenge game information screen that includes race conditions included in the challenge race. When the switch button 68 is pressed, the screen switches to the challenge game information screen.

When the switch button is pressed on the skill acquisition screen, the display unit 56 refers to the race conditions in the challenge game information 50D, or the turn information in the training scenario information 50E, to display a challenge game information screen that shows the race conditions included in the challenge game (a challenge race).

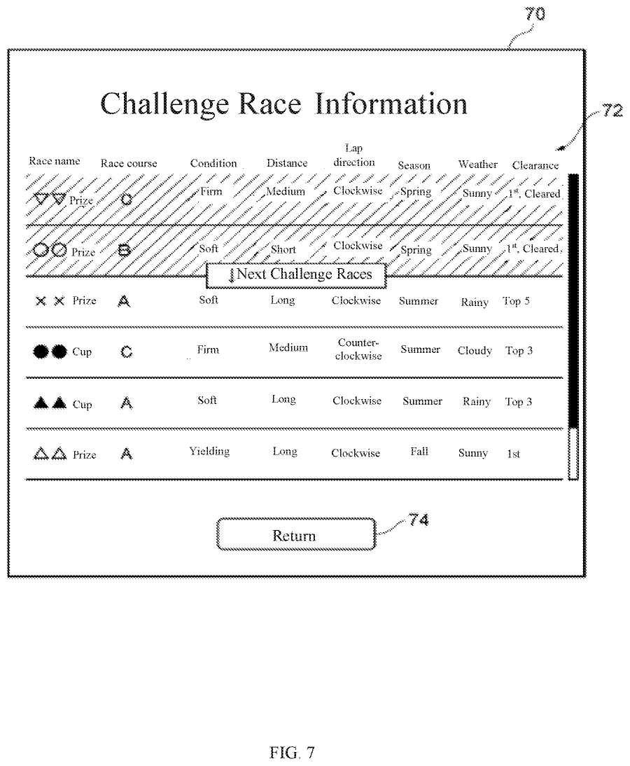

FIG. 7 is a diagram showing an example of a challenge game information screen 70 according to this embodiment.

As shown in FIG. 7, the challenge game information screen 70 is provided with a condition information area 72 and a return button 74. The condition information area 72 shows the race name, race course attributes (race course name and condition), race distance, lap direction, season, weather, and clearance conditions as race conditions for each challenge race. In the condition information area 72, a mark is made indicating the next challenge race (the challenge race associated with the current turn). Also, in the condition information area 72, challenge races that have been cleared by the character to be trained are grayed out. The return button 74 is a button for switching to the skill acquisition screen (the screen that was displayed immediately before).

Going back to FIG. 5, the processing moves to the processing of step SP20.

(Step SP20)

The control unit 52 causes the character to be trained to acquire the skill selected for acquisition on the skill acquisition screen. The display unit 56 then causes the touch panel 32 to display a challenge game start screen that includes a challenge game start button and a skill button. Then, the processing moves to the processing of step SP22.

(Step SP22)

The control unit 52 determines whether or not the player has pressed the challenge game start button. For example, the control unit 52 makes a negative determination if the skill button has been pressed by the player. If the determination is positive, the processing then moves to the processing of step SP24. On the other hand, if the determination is negative, the processing moves to the processing of step SP18.

(Step SP24)

The display unit 56 causes the touch panel 32 to display a strategy selection screen that includes selection buttons for selecting a strategy (breaking away, leading, head-to-head, pursuing) for the character to be trained. The control unit 52 then receives the selection of one of the displayed selection buttons from the player. The control unit 52 then executes the challenge game (a challenge race) associated with the current turn based on the selected strategy. In this embodiment, the control unit 52 refers to the selected strategy, the current parameters and acquired skills of the character to be trained in the player information 50A, the race conditions and parameters of rival character information in the challenge game information 50D, etc., and decides on the performance (finish order) in the challenge game. Here, if the character to be trained has acquired a skill that matches the race conditions included in the challenge game (a challenge race), the control unit 52 activates that skill to raise the finish order of the character to be trained. Then, the processing moves to the processing of step SP26.

(Step SP26)

The control unit 52 refers to the clearance conditions in the race conditions in the challenge game information 50D, and determines whether or not the performance of the character to be trained in the challenge game executed in step SP24 satisfies the clearance conditions (such as coming in fifth place or higher). If the determination is positive, the processing then moves to the processing of step SP28. On the other hand, if the determination is negative, the processing ends the processing series shown in FIG. 5.

(Step SP28)

The display unit 56 causes the touch panel 32 to display a results screen that includes the performance of the character to be trained in the challenge game executed in step SP24. The awarding unit 54 then refers to the reward information in the challenge game information 50D and grants a reward (skill points, etc.) according to the performance in the challenge game executed in step SP24. The display unit 56 then causes the touch panel 32 to display a reward screen that includes the granted reward. Then, the processing moves to the processing of step SP34.

(Step SP30)

The display unit 56 causes the touch panel 32 to display a training game start screen that includes selection buttons for various kinds of training, rest, and practice races. The control unit 52 then receives from the player the selection of one of the displayed selection buttons. Then, the processing moves to the processing of step SP32.

(Step SP32)

The control unit 52 executes the training game selected in step SP30. The awarding unit 54 then refers to the result information in the training game information 50C, and changes (for example, increases) the parameters of the character to be trained according to the execution state of the selected training game, or awards skill points to the character to be trained according to that training game. Then, the processing moves to the processing of step SP34.

(Step SP34)

The control unit 52 refers to the occurrence rate in the event information 50G and selects an event to be generated. For example, the control unit 52 changes the occurrence rate depending on the support characters selected in step SP10. Also, for example, the control unit 52 changes the occurrence rate depending on the performance of the character to be trained in the challenge game executed in step SP24, or the training game (such as the type of training) selected in step SP30. Then, the processing moves to the processing of step SP36.

(Step SP36)

The display unit 56 refers to an event image in the event information 50G and causes the touch panel 32 to display an event screen that shows the event selected in step SP34. The control unit 52 then refers to the skills in the event information 50G and adds the skills corresponding to that event to the acquirable skills of the character to be trained. If the occurrence of an event was not selected at step SP34, the event screen is not displayed and the acquirable skills are not added. Then, the processing moves to the processing of step SP38.

(Step SP38)

The control unit 52 adds 1 to the current turn of the training scenario. Then, the processing moves to the processing of step SP40.

(Step SP40)

The control unit 52 determines whether or not the training scenario has ended. For example, the control unit 52 refers to the turn information in the training scenario information 50E, and if the current turn exceeds the number of turns included in the training scenario, the control unit 52 makes a positive determination. If the determination is positive, the processing ends the processing series shown in FIG. 5. On the other hand, if the determination is negative, the processing moves to the processing of step SP14.

Technical Improvements

In this embodiment, a computer is made to function as a control unit 52 for causing the main control unit (controller) 30 to execute, in a specific order, a training game and a challenge game in which a character to be trained attempts to achieve a target in a training scenario for training the character; an awarding unit 54 for awarding skill points to the character to be trained based on the execution state of the training game or the challenge game; and a display unit 56 for causing the touch panel 32 to display a skill acquisition screen in which the character to be trained acquires one or more skills from among the acquirable skills of the character to be trained by consuming the awarded skill points, wherein when the character to be trained has acquired a skill that matches a condition included in the challenge game, the control unit 52 activates the skill to be exhibited in the challenge game, and causes the touch panel 32 to display, on the skill acquisition screen, a list of the acquirable skills and information on a condition included in a challenge game to be executed later.

With this configuration, information on the conditions included in the challenge game to be executed later is displayed on the skill acquisition screen, which enables clearer visualization of the information on the conditions for exhibiting the skills in the subsequently-executed challenge games. This improved configuration/function of the information processing device allow the player to easily and accurately recognize the skills that the character to be trained should acquire.

Also, in this embodiment, a computer is made to function as a control unit 52 for causing the controller to execute, in a specific order, a training game and a challenge game in which a character to be trained attempts to achieve a target in a training scenario for training the character; an awarding unit 54 for awarding skill points to the character to be trained based on the execution state of the training game or the challenge game; and a display unit 56 for causing the touch panel 32 to display a skill acquisition screen in which the character to be trained acquires one or more skills from among the acquirable skills of the character to be trained by consuming the awarded skill points, wherein when the character to be trained has acquired a skill that matches a condition included in the challenge game, the control unit 52 activates the skill to be exhibited in the challenge game, and causes the touch panel 32 to display, on the skill acquisition screen, a list of the acquirable skills, wherein in the list, acquirable skills that match and acquirable skills that do not match a condition included in the challenge game to be executed later are displayed distinguishably from each other, e.g., in different formats.

This configuration enables clearer visualization of the acquirable skills that match the conditions for exhibiting the skills in the subsequently-executed challenge games on the skill acquisition screen. This improved configuration/function of the information processing device allow the player to easily recognize the skills that the character to be trained should acquire hereafter.

Also, in this embodiment, the control unit 52 adds skills selected with the predetermined probability through execution of the training game or the challenge game to the acquirable skills.

This configuration enables, even when a skill with which the player is not familiar is added to the acquirable skills, clearer visualization of such skill, as a skill that the character should acquire. This improved configuration/function of the information processing device allow the player to easily recognize the skills that the character should acquire.

Also, in this embodiment, the predetermined probability changes depending on the support characters used by the player in a training scenario.

This configuration, even when a skill with which the player is not familiar is added to the acquirable skills through the use of a new support character, clearer visualization of such skill, as a skill that the character should acquire. This improved configuration/function of the information processing device allow the player to easily recognize the skills that the character should acquire.

Also, in this embodiment, the control unit 52 restricts the continuation of the training scenario when the performance in the challenge game of the character to be trained does not satisfy a clearance condition of the challenge game.

With this configuration, as the touch panel 32 displays the information on the condition included in the challenge game to be executed later even when the performance does not satisfy the clearance condition, the information processing device can assist the player so that continuation of a training scenario will not be restricted.

Also, in this embodiment, a challenge game is a race in which the character to be trained competes in a race course, and the clearance condition is to place within a specific finish order.

With this configuration, as the touch panel 32 displays the information on the condition included in the challenge game to be executed later, the information processing device can assist the player so that the character to be trained is within the specific finish order and continuation of a training scenario is not restricted.

Also, in this embodiment, the conditions included in a challenge game include at least one of the following: race course attributes, race distance, lap direction, season, and weather.

With this configuration, as the touch panel 32 displays the conditions of a challenge game to be executed later and the skills that match the conditions on the skill acquisition screen, the information processing device can assist the player to recognize without much effort the skills that the character should acquire.

### MODIFICATION EXAMPLES

The present invention is not limited to or by the above specific examples. That is, suitable design changes made to the above specific examples by a person skilled in the art are also encompassed by the scope of the present invention as long as they still have the features of the present invention. Also, the elements of the embodiments described above and the modified examples (discussed below) can be combined to the extent that this is technically possible, and these combinations are also encompassed by the scope of the present invention as long as they still have the features of the present invention.

For example, in this embodiment, a case was described in which a battle game was a game in which a character to be trained in a training scenario was pitted against an enemy character, but it may instead be a team battle in which a team made up of multiple characters to be trained competes against a team made up of multiple enemy characters.

Also, in this embodiment, a case was described in which the control unit 52 received the selection of a specific number (such as five) of support characters to be used from among the player's possessed characters, but a subset of this specific number (such as one) may instead be a selection that is received from among the support characters possessed by other players. Examples of other players include a friend player of the player, a player whose player ranking is similar to that of the player, and the like.

Also, in this embodiment, a case was described in which the control unit 52 ended the training scenario when the clearance condition was not satisfied in a challenge game, but the player may instead be allowed to choose whether to continue the training scenario (challenge game) or to end the training scenario. For example, the control unit 52 may allow the player to continue by consuming paid stones, free stones, or continuation items possessed by the player.

Also, in this embodiment, a case was described in which the control unit 52 added a skill corresponding to an event that has occurred through an event lottery to the acquirable skills of the character to be trained, but when a skill that is the same as an acquirable skill of the character to be trained is to be added, the consumed skill points of that skill may be reduced.

Also, in this embodiment, a case was described in which the control unit 52 performed an event lottery after the execution of a training game or a challenge game, but the event lottery may be performed before the execution of the training game or the challenge game (at the start of a turn). The display unit 56 can thereby display on the training game start screen a preview of the training in which an event will occur.

Also, in this embodiment, a case was described in which the awarding unit 54 awarded skill points to the character to be trained, but these may instead be awarded to the player. Also, a case was described in which the awarding unit 54 awarded skill points according to the performance in a challenge game, but it may instead award skill points according to the performance in a practice race.

Also, in this embodiment, a case was described in which the display unit 56 displayed on the skill acquisition screen a mark on skills that matched the race conditions included in the challenge game (a challenge race) to be executed next, but it may instead change the display format (character color, format, background color, etc.) representing the matching skills. Also, the display unit 56 may display different display formats on the skill acquisition screen to distinguish between skills that match and skills that do not match the race conditions included in some or all of the challenge games to be executed later. For example, on the skill acquisition screen, the display unit 56 may put a mark on skills that match the race conditions included in at least a specific number (such as three) of challenge games to be executed later.

Also, on the skill acquisition screen, the display unit 56 may not put a mark on a skill when the current skill points awarded to a character to be trained are less than the consumed skill points of the skills that match the race conditions included in a challenge game (a challenge race) to be executed later.

Also, in this embodiment, a case was described in which the display unit 56 displayed the skill acquisition screen before the start of a challenge game, but the display unit 56 may instead display the skill acquisition screen before the start of a training game.

Also, in this embodiment, a case was described in which the display unit 56 displayed on the challenge game information screen the race name, race course attributes (race course name, condition), race distance, lap direction, season, weather, and clearance conditions as race conditions for each challenge race, but information determined just for the current turn may be displayed instead. For example, the display unit 56 may display on the challenge game information screen the race course condition and weather for challenge races associated with previous turns, and not display the race course condition and weather for challenge races associated with turns after the current turn.

Also, the display unit 56 may display on the challenge game information screen the gate number (starting gate) of the character to be trained. Here again, for example, the display unit 56 may display on the challenge game information screen the gate number for challenge races associated with previous turns, and not display the gate number for challenge races associated with turns after the current turn. The display unit 56 may display on the challenge game information screen whether the character to be trained will start from an inside gate (gates 1 to 3) or an outside gate (gates 4 to 6).

Also, the display unit 56 may display on the challenge game information screen the strategy of a rival character (breaking away, leading, head-to-head, pursuing) in a challenge game (a challenge race). The display unit 56 may display on the challenge game information screen the number of rival characters adopting each strategy.

Also, in this embodiment, a case was described in which the challenge game was a race, but the challenge game may instead be any of various sports games (such as a soccer game, baseball game, basketball game, etc.) or battle games (such as a shooting game, battle royale game, or fighting game), and so on.

Although the disclosure has been described with respect to only a limited number of embodiments, those skilled in the art, having benefit of this disclosure, will appreciate that various other embodiments may be devised without departing from the scope of the present invention. Accordingly, the scope of the invention should be limited only by the attached claims.

### REFERENCE SIGNS LIST

10: server device, 12: terminal device, 50: storage unit, 52: control unit, 54: awarding unit, 56: display unit

What is claimed is:

1. A non-transitory computer readable recording medium storing instructions for an information processing device that comprises a control device connected via a network to a terminal device that comprises a controller and a display, the instructions causing the control device to execute:
causing the controller to execute, in a training scenario for training a character, a training game and a challenge game in which the character attempts to achieve a target, in a specific order;
awarding a skill point to the character based on an execution state of the training game or the challenge game;
causing the display to display a skill acquisition screen in which the character acquires one or more skills from among acquirable skills of the character by consuming the skill point;
when the character has acquired a skill that matches a condition included in the challenge game, activating the skill to be exhibited in the challenge game; and
causing the display to display, on the skill acquisition screen, information on a condition included in a subsequently-executed challenge game.

2. A non-transitory computer readable recording medium storing instructions for an information processing device that comprises a control device connected via a network to a terminal device that comprises a controller and a display, the instructions causing the control device to execute:
causing a controller to execute, in a training scenario for training a character, a training game and a challenge game in which the character attempts to achieve a target, in a specific order;
awarding a skill point to the character based on an execution state of the training game or the challenge game;
displaying a skill acquisition screen in which the character acquires one or more skills from among acquirable skills of the character by consuming the skill point;
when the character has acquired a skill that matches a condition included in the challenge game, activating the skill to be exhibited in the challenge game; and
causing the display to display, on the skill acquisition screen, a list of acquirable skills, wherein
in that list, acquirable skills that match and acquirable skills that do not match a condition included in a subsequently-executed challenge game are displayed distinguishably from each other.

3. The non-transitory computer readable recording medium according to claim 1, wherein
the instructions further cause the control device to add, to the acquirable skills, a skill selected with a predetermined probability through execution of the training game or the challenge game.

4. The non-transitory computer readable recording medium according to claim 3, wherein
the predetermined probability changes depending on a support character used by a player in the training scenario.

5. The non-transitory computer readable recording medium according to claim 1, wherein
the instructions further cause the control device to restrict continuation of the training scenario when a performance of the character in the challenge game does not satisfy a clearance condition of the challenge game.

6. The non-transitory computer readable recording medium according to claim 5, wherein the challenge game is a race in which the character competes in a race course, and the clearance condition is to place within a specific finish order.

7. The non-transitory computer readable recording medium according to claim 6, wherein
the condition included in the subsequently-executed challenge game includes at least one of a race course attribute, a race distance, a lap direction, a season, and a weather.

8. An information processing device, comprising:
a control device that:
is connected via a network to a terminal device that comprises a controller and a display,
causes the controller to execute, in a training scenario for training a character, a training game and a challenge game in which the character attempts to achieve a target, in a specific order,
awards a skill point to the character based on an execution state of the training game or the challenge game,
causes the display to display a skill acquisition screen in which the character acquires one or more skills from among acquirable skills of the character by consuming the skill point,
when the character has acquired a skill that matches a condition included in the challenge game, activates the skill to be exhibited in the challenge game, and
causes the display to display, on the skill acquisition screen, information on a condition included in a subsequently-execute challenge game.

9. An information processing device, comprising:
a control device that:
is connected via a network to a terminal device that comprises a controller and a display,
causes the controller to execute, in a training scenario for training a character, a training game and a challenge game in which the character attempts to achieve a target, in a specific order,
awards a skill point to the character based on an execution state of the training game or the challenge game,
causing the display to display a skill acquisition screen in which the character acquires one or more skills from among acquirable skills of the character by consuming the skill point,
when the character has acquired a skill that matches a condition included in the challenge game, activates the skill to be exhibited in the challenge game, and
causes the display to display, on the skill acquisition screen, a list of acquirable skills, wherein
in the list, acquirable skills that match and acquirable skills that do not match a condition included in a subsequently-execute challenge game are displayed distinguishably from each other.
